(19) United States
(12) Patent Application Publication
(10) Pub. No.: US 2024/0388597 A1
(43) Pub. Date: Nov. 21, 2024

(54) DATA PROCESSING APPARATUS, DATA PROCESSING METHOD, AND RECORDING MEDIUM

(71) Applicant: NEC Corporation, Minato-ku, Tokyo (JP)

(72) Inventors: Hirofumi Ueda, Tokyo (JP); Kazuaki Nakajima, Tokyo (JP); io Furuyama, Tokyo (JP)

(73) Assignee: NEC Corporation, Minato-ku, Tokyo (JP)

(21) Appl. No.: 18/694,078

(22) PCT Filed: Oct. 29, 2021
(86) PCT No.: PCT/JP2021/040098

§ 371 Date: Mar. 21, 2024

(51) Int. Cl. H04L 9/40; G06Q 50/04

(52) U.S. Cl. CPC H04L 63/1433; G06Q 50/04

(57) ABSTRACT

The present invention accurately identifies factors (threats) that cause security risks to appear in a communication system. An acquisition unit (11) acquires identification information identifying a specific component device of a communication system; a collection unit (12) uses the identification information to collect relationship information indicating a component that has a connection or relationship with the specific component device, and safety information related to the safety of the specific component device and the components thereof in terms of information security; and a display unit (13) displays the safety information together with or in association with the relationship information.

### TECHNICAL FIELD

The present invention relates to a data processing apparatus, a data processing method, and a recording medium, and more particularly, to a data processing apparatus, a data processing method, and a recording medium related to an information communication device configuring a communication system.

### BACKGROUND ART

There is provided a communication system that enables remote control of industrial equipment by using a control system by connecting devices such as sensors, cameras, Internet of Things (IoT) devices, and communication terminals in a factory, and industrial equipment such as a manufacturing apparatus and a transportation equipment to the control system via a communication network. For example, the communication system is an IoT system, an operational technology (OT) control system, or an information communication technology (ICT) system. In recent years, there has been an increasing risk (threat) of such a communication system being subjected to a cyberattack from the outside or the inside.

In order to operate a communication system safely, countermeasures against vulnerability of software operating in the communication system are also important. The vulnerability of the software is a defect in information security caused by a fault of a program or a design error. Alternatively, a cyberattack may be executed by using a backdoor invisible to a user. In a case where the vulnerability of software is left unchecked, not only does a risk of a communication system being subjected to a cyberattack increase, but business damage also increases when the communication system is subjected to the cyberattack. Therefore, a related technique for determining the influence of vulnerability of software has been developed (for example, PTL 1).

### CITATION LIST

### Patent Literature

PTL 1: Japanese Patent No. 5781616

### SUMMARY OF INVENTION

### Technical Problem

In general, as a communication system becomes larger, products of more manufacturers are mixed in the communication system. There are cases where standards regarding confidentiality (safety) of information vary depending on manufacturers. The likelihood of being targeted by an attacker varies depending on manufacturers or products. As a result, the cost of checking whether each constituent device of the communication system is safe increases, and a security risk of the communication system increases. In particular, in a large-scale communication system, it is difficult to accurately specify a factor (threat) that makes a security risk more evident.

The present invention has been made in view of the above problems, and an object of the present invention is to provide a technique capable of accurately specifying a factor (threat) that makes a security risk more evident.

### Solution to Problem

According to an aspect of the present invention, there is provided a data processing apparatus including acquisition means for acquiring identification information for identifying a specific constituent device of a communication system; collecting means for collecting, by using the identification information, relationship information indicating a constituent component having a connection or a relationship with the specific constituent device and safety information related to safety in terms of information security of the specific constituent device and the constituent component; and display means for displaying the safety information together with or in association with the relationship information.

According to another aspect of the present invention, there is provided a data processing method including acquiring identification information for identifying a specific constituent device of a communication system; collecting, by using the identification information, relationship information indicating a constituent component having a connection or a relationship with the specific constituent device and safety information related to safety in terms of information security of the specific constituent device and the constituent component; and displaying the safety information together with or in association with the relationship information.

According to still another aspect of the present invention, there is provided a recording medium storing a program for causing a computer to execute acquiring identification information for identifying a specific constituent device of a communication system; collecting, by using the identification information, relationship information indicating a constituent component having a connection or a relationship with the specific constituent device and safety information related to safety in terms of information security of the specific constituent device and the constituent component; and displaying the safety information together with or in association with the relationship information.

### Advantageous Effects of Invention

According to one aspect of the present invention, it is possible to accurately specify a factor (threat) that makes a security risk more evident in a communication system.

### BRIEF DESCRIPTION OF DRAWINGS

FIG. 1 is a diagram schematically illustrating an example of a communication system that is an entity of a virtual model generated by a data processing apparatus according to first to third example embodiments.

FIG. 2 is a block diagram illustrating a configuration of a data processing apparatus according to the first example embodiment.

FIG. 3 is a flowchart illustrating an operation of the data processing apparatus according to the first example embodiment.

FIG. 4 is a diagram illustrating an example of relationship information and safety information displayed by a display unit of a data processing apparatus according to the second example embodiment.

FIG. 5 is a block diagram illustrating a configuration of a data processing apparatus according to the third example embodiment.

FIG. 6 is a flowchart illustrating an operation of the data processing apparatus according to the third example embodiment.

FIG. 7 is a diagram illustrating a first example of relationship information and safety information displayed by a display unit of the data processing apparatus according to the third example embodiment.

FIG. 8 is a diagram illustrating a second example of the relationship information and the safety information displayed by the display unit of the data processing apparatus according to the third example embodiment.

FIG. 9 is a diagram illustrating a third example of the relationship information and the safety information displayed by the display unit of the data processing apparatus according to the third example embodiment.

FIG. 10 is a diagram illustrating an example of a hardware configuration of the data processing apparatus according to any one of the first to third example embodiments.

### EXAMPLE EMBODIMENT

Some example embodiments of the present invention will be described below with reference to the drawings.

### (Communication System 1)

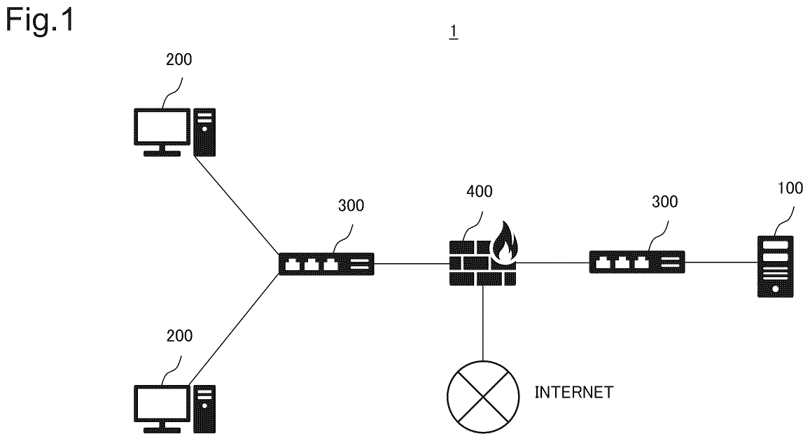

An example of a configuration of the communication system 1 will be described with reference to FIG. 1. FIG. 1 is a diagram schematically illustrating an example of a configuration of the communication system 1. For example, the communication system 1 includes an Internet of Things (IoT) system, an information and communication technology (ICT) system, a local area network (LAN), an infrastructure system, and an industrial control system (ICS). However, the communication system 1 may be something other than these examples.

The communication system 1 is an entity of a virtual model generated by data processing apparatuses 10, 20, and 30 according to first to third example embodiments that will be described later. That is, the data processing apparatuses 10, 20, and 30 execute data processing for generating a virtual model of the communication system 1.

As illustrated in FIG. 1, the communication system 1 includes a switch 300 and a firewall 400 in addition to the control server 100 and the client terminal 200 (hereinafter, referred to as nodes 100 and 200). The communication system 1 constructs a communication network such as a local area network (LAN) or a wide area network (WAN). In FIG. 1, a line connecting constituent devices (the nodes 100 and 200, the switch 300, and the firewall 400) of the communication system 1 indicates that the constituent devices can communicate with each other.

The nodes 100 and 200 are hardware devices or software having a communication function and an information processing function (calculation function). For example, the nodes 100 and 200 are personal computers, human machine interfaces (HMIs), control servers, log servers, programmable logic controllers (PLCs), application programming interfaces (APIs), Internet of Things (IoT) devices, or mobile devices. Here, it is assumed that the node 100 is a client terminal (for example, a personal computer), and the node 200 is a control server.

The switch 300 is a network device that achieves a routing function through hardware processing, and is, for example, Ethernet. As illustrated in FIG. 1, the switch 300 has a function of transferring communication between constituent devices of the communication system 1.

The firewall 400 is provided between the constituent devices of the communication system 1 and between the communication system 1 and an external network (the Internet in FIG. 1), and restricts data communication or communication connection for reasons such as computer security. The firewall 400 may be implemented in a router, or may be achieved as application software (a so-called application firewall).

The configuration of the communication system 1 illustrated in FIG. 1 is merely an example. For example, the communication system 1 may further include industrial equipment that is a target controlled by a PLC. Each of the node 100 and the node 200 may be one, or may be any plurality of two or more.

In the following description, “node 100 (200)” indicates at least one of the node 100 or the node 200. Hereinafter, a path of a cyberattack will be referred to as an “attack path”, and a procedure of the cyberattack will be referred to as an “attack scenario”.

### First Example Embodiment

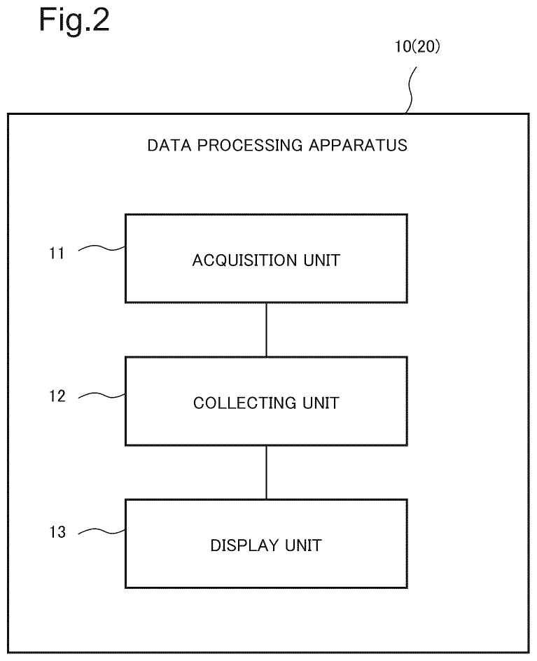

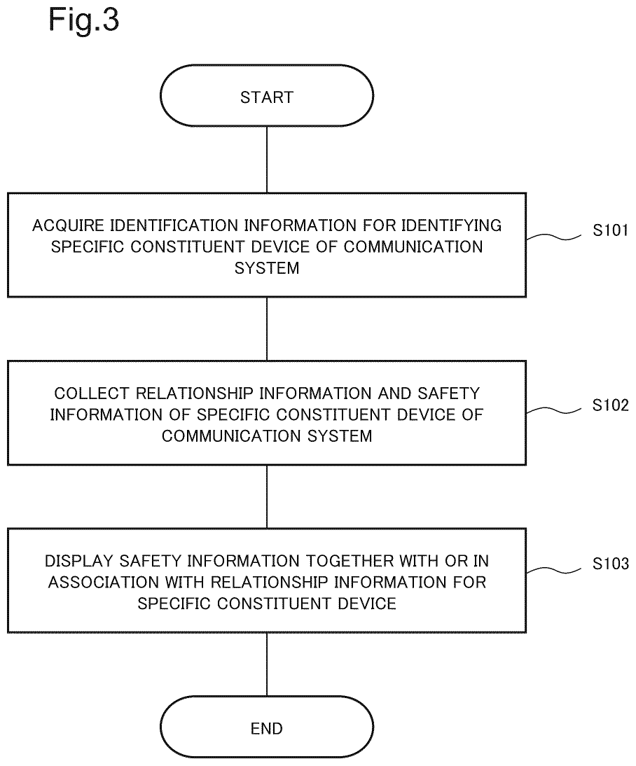

The first example embodiment will be described with reference to FIGS. 2 and 3.

(Data processing apparatus 10)

A configuration of the data processing apparatus 10 according to the first example embodiment will be described with reference to FIG. 2. FIG. 2 is a block diagram illustrating a configuration of the data processing apparatus 10.

As illustrated in FIG. 2, the data processing apparatus 10 includes an acquisition unit 11, a collecting unit 12, and a display unit 13.

The acquisition unit 11 acquires identification information for identifying a specific constituent device of the communication system 1. The acquisition unit 11 is an example of acquisition means.

For example, the acquisition unit 11 receives an operation of designating or selecting a specific constituent device among the constituent devices (the nodes 100 and 200, the switch 300, and the firewall 400) of the communication system 1 (FIG. 1) from an input device (not illustrated).

The acquisition unit 11 receives information indicating the content of an operation on the input device (not illustrated). The acquisition unit 11 identifies the specific constituent device based on the information indicating the content of the operation. For example, the acquisition unit 11 searches for and acquires information (for example, an identifier of the constituent device) for identifying the designated or selected specific constituent device from a first database (not illustrated).

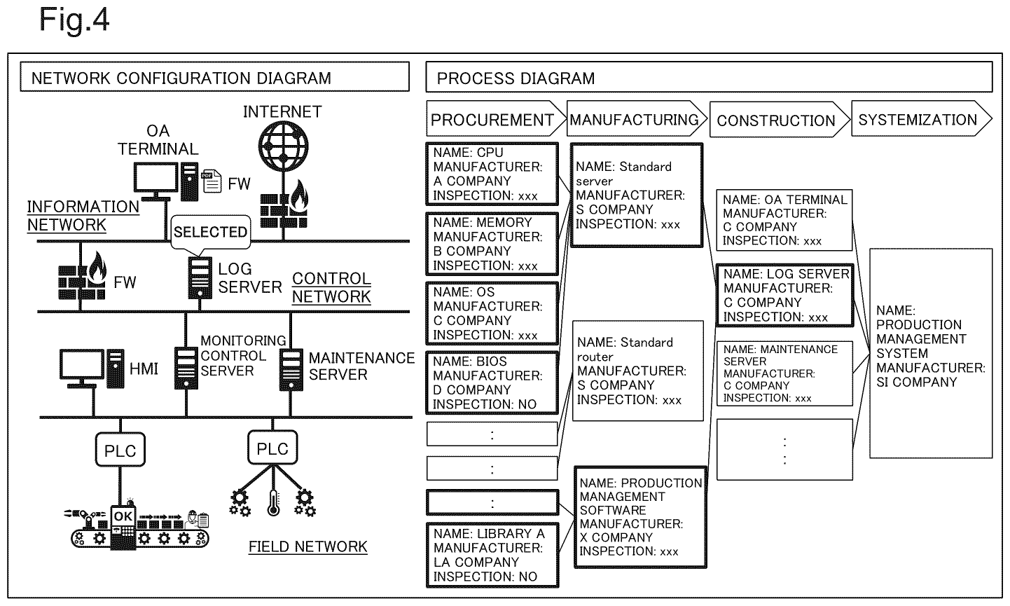

Alternatively, the acquisition unit 11 may acquire identification information for identifying a specific constituent device selected from among constituent devices displayed on a network configuration diagram (FIG. 4) of the communication system 1.

The acquisition unit 11 outputs the identification information for identifying the specific constituent device to the collecting unit 12.

The collecting unit 12 collects the relationship information and the safety information by using the identification information. The relationship information indicates a constituent component having a connection or a relationship with a specific constituent device. The safety information is related to safety in terms of information security of a constituent device and a constituent component. The collecting unit 12 is an example of collecting means.

For example, the collecting unit 12 receives, from the acquisition unit 11, the identification information (for example, an identifier of a device) for identifying the specific constituent device of the communication system 1.

First, the collecting unit 12 acquires the relationship information indicating a connection or a relationship between the specific constituent device and another constituent device of the communication system 1 (FIG. 1). A constituent device having a connection or a relationship may be included in a single attack path, and thus also has a connection or a relationship in terms of information security. The constituent devices include hardware and software components, and parts and modules configuring the hardware and the software. Here, a hardware part is a replaceable part such as a processor or a memory. A software part is a constituent element other than a module, such as a function or a library. A hardware module is a set of replaceable parts configured to perform functions. A software module is a part of software and is an independent program.

The collecting unit 12 searches for and acquires relationship information indicating a connection or a relationship between the constituent devices of the communication system 1 from a second database (not illustrated) by using information for specifying a specific constituent device of the communication system 1. For example, the relationship information is information indicating a manufacturing process of the communication system 1, information indicating an attack path that is an intrusion path in a cyberattack obtained through risk analysis or the like, or information indicating an attack scenario including a plurality of possible attack paths in a cyberattack.

Second, the collecting unit 12 collects safety information related to safety in terms of information security of a constituent device. The collecting unit 12 is an example of collecting means. The safety information includes an inspection result (for example, source code inspection and back door inspection) of information security inspection for a constituent device. The safety information includes information (for example, a manufacturer name) specifying a product or a manufacturer of the constituent device.

For example, the collecting unit 12 acquires, from the acquisition unit 11, relationship information indicating a connection or a relationship between the constituent devices (in FIG. 1, the nodes 100 and 200, the switch 300, and the firewall 400) of the communication system 1.

The collecting unit 12 acquires information regarding a constituent device of the communication system 1 from a third database (not illustrated) that stores the information regarding the constituent device of communication system 1 (for example, an identifier of a product, a manufacturer name, and the presence or absence of a result of an information security inspection).

Next, the collecting unit 12 collects safety information related to safety in terms of information security of the constituent device of the communication system 1 from a fourth database (not illustrated) that stores software analysis information. Examples of software analysis include source code analysis, binary code analysis, open source software (OSS) analysis, coding check, port scan, and software installation scan.

For example, the safety information related to the safety in terms of information security of the constituent device of the communication system 1 includes an inspection result of an information security inspection for the constituent device of the communication system 1.

Alternatively, the collecting unit 12 may acquire an inspection result of an information security inspection for a specific constituent device of the communication system 1 from a software analysis device (not illustrated). The data processing apparatus 10 may include, as a part thereof, a software analysis unit that executes analysis of a specific constituent device.

Alternatively, the safety information related to safety in terms of information security of the specific constituent device of the communication system 1 may include a result of a backdoor inspection.

The collecting unit 12 outputs, to the display unit 13, relationship information for the specific constituent device of the communication system 1 and safety information related to safety in terms of information security of the specific constituent device of the communication system 1.

The display unit 13 displays the safety information together with or in association with the relationship information for the specific constituent device of the communication system 1. The display unit 13 is an example of display means.

The display unit 13 may display the safety information together with or on the manufacturing process diagram of the communication system 1.

Alternatively, the display unit 13 may display the safety information on the manufacturing process diagram of the communication system 1.

Alternatively, the display unit 13 may display the manufacturing process diagram in which the safety information is displayed together with a network configuration diagram of the communication system 1.

For example, the display unit 13 receives, from the collecting unit 12, the relationship information indicating a connection or a relationship between the constituent devices of the communication system 1. The display unit 13 receives, from the collecting unit 12, the safety information related to safety in terms of information security of the constituent devices of the communication system 1.

The display unit 13 generates first image data including the relationship information. The display unit 13 generates second image data including the safety information.

The display unit 13 combines the first image data and the second image data to form a single screen, thereby generating third image data. For example, in the third image, the first image and the second image are arranged in parallel on the left and right (second example embodiment).

The display unit 13 outputs the third image data to a display device (for example, a monitor) (not illustrated). The display unit 13 displays the third image on a screen of the display device.

The third image presents the relationship information included in the first image data and the safety information included in the second image data presenting the safety information. Since the relationship information and the safety information are displayed together on the same screen instead of individually, there is comprehensiveness of information.

With the comprehensiveness of information, not only the connection or the relationship between the constituent devices but also the safety of the constituent devices can be ascertained at a glance. Therefore, in the communication system 1, a factor (threat) that makes a security risk more evident can be accurately specified.

The display unit 13 may store the relationship information and the safety information in association with each other in a fifth database (not illustrated).

### (Operation of Data Processing Apparatus 10)

An operation of the data processing apparatus 10 according to the first example embodiment will be described with reference to FIG. 3. FIG. 3 is a flowchart illustrating a flow of processing executed by each unit of the data processing apparatus 10.

As illustrated in FIG. 3, first, the acquisition unit 11 acquires identification information for identifying a specific constituent device of the communication system 1 (S101). The acquisition unit 11 outputs the identification information for identifying the specific constituent device to the collecting unit 12.

The collecting unit 12 receives the identification information for identifying the specific constituent device from the acquisition unit 11.

Next, the collecting unit 12 acquires relationship information indicating a constituent component having a connection or a relationship with the specific constituent device by using the identification information. The collecting unit 12 collects safety information related to safety in terms of information security of the specific constituent device and the constituent component by using the identification information (S102).

The collecting unit 12 outputs the relationship information and the safety information for the specific constituent device of the communication system 1 to the display unit 13.

The display unit 13 receives the relationship information and the safety information for the specific constituent device of the communication system 1 from the collecting unit 12.

Thereafter, the display unit 13 displays the safety information together with or in association with the relationship information (S103).

For example, the display unit 13 generates third image data including the relationship information and the safety information by combining first image data including the relationship information and second image data including the safety information. The display unit 13 displays the generated third image data on a screen of a display device (not illustrated).

The display unit 13 may store the relationship information and the safety information in association with each other in a fifth database (not illustrated).

As described above, the operation of the data processing apparatus 10 according to the first example embodiment is ended.

### Effects of Present Example Embodiment

According to the configuration of the present example embodiment, the acquisition unit 11 acquires identification information for identifying a specific constituent device of the communication system 1. The collecting unit 12 collects relationship information indicating a constituent component having a connection or a relationship with the specific constituent device and safety information related to safety in terms of information security of the specific constituent device and the constituent component by using the identification information. Relationship information indicating a connection or a relationship between the constituent devices of the communication system 1 is input. The display unit 13 displays the safety information together with or in association with the relationship information.

Since the relationship information and the safety information are displayed together instead of individually, there is comprehensiveness of information. With the comprehensiveness of information, not only the connection or the relationship between the constituent devices but also the safety of the constituent devices can be ascertained at a glance. Therefore, in the communication system 1, a factor (threat) that makes a security risk more evident can be accurately specified.

### Second Example Embodiment

The second example embodiment will be described with reference to FIG. 4. In the second example embodiment, an example of the relationship information and the safety information described in the first example embodiment will be described. A configuration and an operation of the data processing apparatus 20 according to the second example embodiment are the same as the configuration and the operation of the data processing apparatus 10 (FIG. 2) according to the first example embodiment. In the second example embodiment, the description of the configuration and the operation of the data processing apparatus 20 will be omitted by referring to the description in the first example embodiment.

### (Example of Relationship Information and Safety Information)

Here, an example in which the safety information is displayed together with the relationship information will be described. In the present example, the relationship information and the safety information are simultaneously displayed in the same image. Alternatively, the first image displaying the relationship information and the second image displaying the safety information may be switched and displayed.

An example of the third image displayed by the display unit 13 (FIG. 2) of the data processing apparatus 20 will be described with reference to FIG. 4. As described in the first example embodiment, in the third image, for example, the first image and the second image are arranged in parallel on the left, right, or up and down. The first image presents the relationship information and the second image presents the safety information.

FIG. 4 is a diagram illustrating an example of a third image. As illustrated in FIG. 4, in an example, the third image includes a network configuration diagram corresponding to the first image and a process diagram corresponding to the second image. The network configuration diagram illustrates a network configuration of the communication system 1. The process diagram illustrates a supply chain from procurement of a constituent device of the communication system 1 to systemization (integration) of the communication system 1.

As illustrated in FIG. 4, the network configuration diagram of the communication system 1 is for displaying a network topology. The network configuration diagram represents a certain connection or relationship between constituent devices (for example, an office automation (OA) terminal and a log server) of the communication system 1. On the other hand, the process diagram of the communication system 1 represents a process through which the communication system 1 is constructed.

The constituent device illustrated in the network configuration diagram illustrated in FIG. 4 corresponds to the constituent device illustrated in the construction process in the process diagram. However, in the process diagram, some of the constituent devices are not illustrated. In FIG. 4, the safety information is displayed in a manufacturing process diagram of the communication system 1.

When an input operation of selecting one constituent device (the “log server” in FIG. 4) in the network configuration diagram illustrated in FIG. 4 is performed by using an input device (not illustrated), the display unit 13 highlights only components and modules configuring the selected constituent device (“log server”) in the process diagram illustrated in FIG. 4.

In FIG. 4, in the process diagram, two of “Standard server” and “Production management software” illustrated in the manufacturing process are highlighted by a mesh pattern. The “central processing unit (CPU)” and the like illustrated in the procurement process also correspond to components or modules configuring the “Standard server” and are thus highlighted.

In FIG. 4, a constituent device (for example, the “OA terminal” in the construction process) unrelated to the selected constituent device (“log server”) is also displayed. However, the display unit 13 may display only a constituent device related to the selected constituent device (“log server”). In this case, the display unit 13 does not need to highlight the constituent device related to the selected constituent device (“log server”). This is because it is not necessary to distinguish the constituent device related to the selected constituent device from the constituent device unrelated to the selected constituent device (“log server”).

### Effects of Present Example Embodiment

According to the configuration of the present example embodiment, the acquisition unit 11 acquires identification information for identifying a specific constituent device of the communication system 1. The collecting unit 12 collects relationship information indicating a constituent component having a connection or a relationship with the specific constituent device and safety information related to safety in terms of information security of the specific constituent device and the constituent component by using the identification information. Relationship information indicating a connection or a relationship between the constituent devices of the communication system 1 is input. The display unit 13 displays the safety information together with or in association with the relationship information.

Since the relationship information and the safety information are displayed together instead of individually, there is comprehensiveness of information. With the comprehensiveness of information, not only the connection or the relationship between the constituent devices but also the safety of the constituent devices can be ascertained at a glance. Therefore, in the communication system 1, a factor (threat) that makes a security risk more evident can be accurately specified.

### Third Example Embodiment

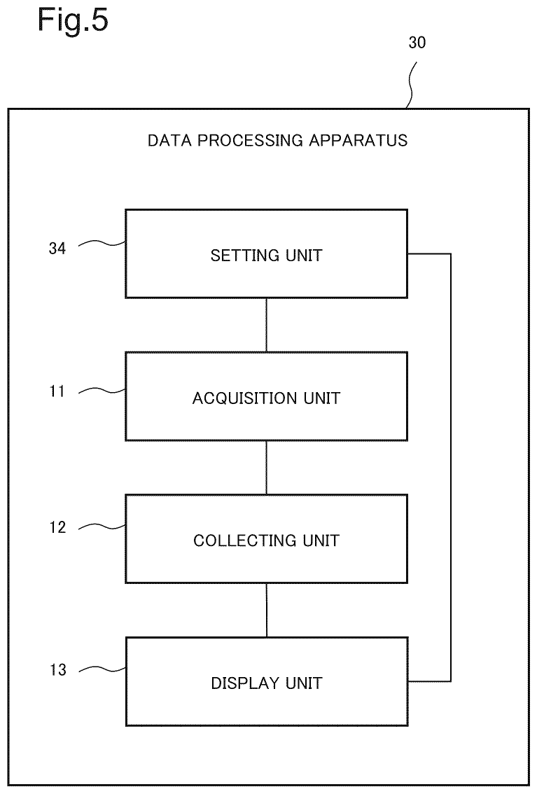

The third example embodiment will be described with reference to FIGS. 5 to 9. In the third example embodiment, a configuration will be described in which an attack path or an attack scenario of a cyberattack obtained through risk analysis or the like for the communication system 1 (FIG. 1) is set, and only relationship information and safety information related thereto are displayed.

In the third example embodiment, the same constituent elements as those described in the first and second example embodiments are denoted by the same reference numerals, and the description thereof will be omitted.

### (Data Processing Apparatus 30)

A configuration of the data processing apparatus 30 according to the third example embodiment will be described with reference to FIG. 5. FIG. 5 is a block diagram illustrating a configuration of the data processing apparatus 30.

As illustrated in FIG. 5, the data processing apparatus 30 includes an acquisition unit 11, a collecting unit 12, and a display unit 13. The data processing apparatus 30 further includes a setting unit 34.

The setting unit 34 sets an attack path or an attack scenario of a cyberattack obtained through risk analysis for the communication system 1 (FIG. 1). The setting unit 34 is an example of setting means.

For example, the setting unit 34 receives an operation of inputting information indicating content of an attack path or an attack scenario of a cyberattack, which is a risk analysis result for the communication system 1, from an input device (not illustrated). For example, the information indicating the content of the attack path or the attack scenario of the cyberattack includes information designating an intrusion port and a target of the attack path. Alternatively, the information indicating the content of the attack path or the attack scenario of the cyberattack includes information indicating an attack step (procedure) of the attack scenario.

The setting unit 34 outputs the information indicating the attack path or the attack scenario of the cyberattack obtained through the risk analysis for the communication system 1 to the acquisition unit 11.

The acquisition unit 11 selects a specific constituent device from among constituent devices related to the attack path or the attack scenario, and acquires identification information of the specific constituent device. For example, the acquisition unit 11 displays a diagram representing the attack path or the attack scenario on a screen of a display device (not illustrated).

The acquisition unit 11 receives an operation of designating or selecting a specific constituent device among the constituent devices (the nodes 100 and 200, the switch 300, and the firewall 400) of the communication system 1 (FIG. 1) from an input device (not illustrated). In this case, the acquisition unit 11 receives only an operation of designating or selecting any one of specific constituent devices from among the constituent devices related to the attack path or the attack scenario.

After a specific constituent device is selected or designated, the acquisition unit 11 outputs identification information for identifying the specific constituent device to the collecting unit 12 as in the first example embodiment.

### (Operation of Data Processing Apparatus 30)

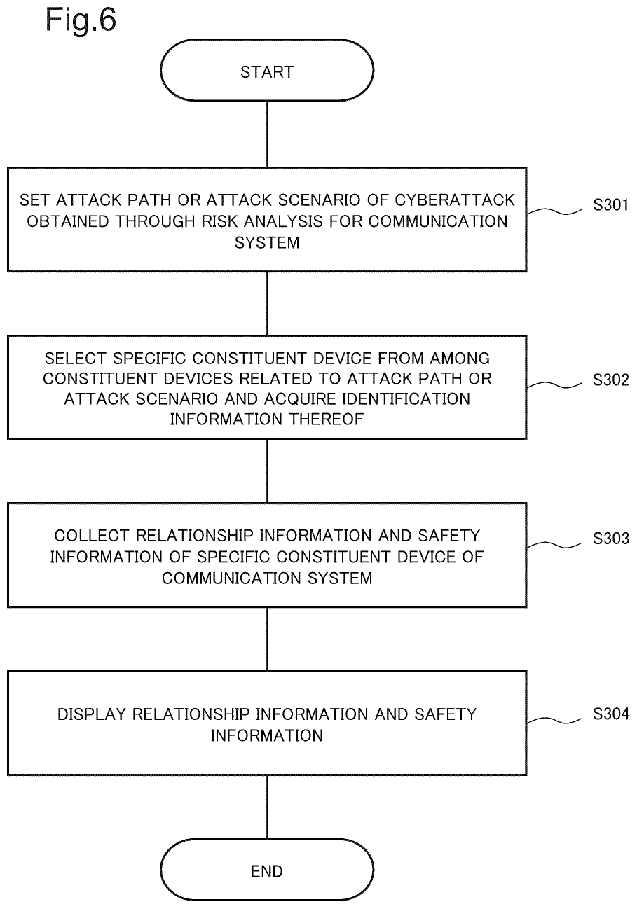

An operation of the data processing apparatus 30 according to the third example embodiment will be described with reference to FIG. 6. FIG. 6 is a flowchart illustrating a flow of processing executed by each unit of the data processing apparatus 30.

As illustrated in FIG. 6, first, the setting unit 34 sets an attack path or an attack scenario of a cyberattack obtained through risk analysis for the communication system 1 (S301). The setting unit 34 outputs the information indicating the attack path or the attack scenario of the cyberattack obtained through the risk analysis for the communication system 1 to the acquisition unit 11.

The acquisition unit 11 receives, from the setting unit 34, the information indicating the attack path or the attack scenario of the cyberattack obtained through the risk analysis for the communication system 1. The acquisition unit 11 selects a specific constituent device from among the constituent devices related to the attack path or the attack scenario based on the information indicating the attack path or the attack scenario of the cyberattack. The acquisition unit 11 acquires identification information for identifying the specific constituent device of the communication system 1 (S302). The acquisition unit 11 outputs the identification information for identifying the specific constituent device to the collecting unit 12.

The collecting unit 12 receives the identification information for identifying the specific constituent device from the acquisition unit 11.

The collecting unit 12 acquires relationship information indicating a constituent component having a connection or a relationship with the specific constituent device by using the identification information. The collecting unit 12 collects safety information related to safety in terms of information security of the specific constituent device and the constituent component (S303).

The collecting unit 12 outputs the relationship information and the safety information for the specific constituent device of the communication system 1 to the display unit 13.

The display unit 13 receives the relationship information and the safety information for the specific constituent device of the communication system 1 from the collecting unit 12.

Thereafter, the display unit 13 displays the safety information together with or in association with the relationship information (S304).

For example, the display unit 13 generates third image data including the relationship information and the safety information by combining first image data including the relationship information and second image data including the safety information. The display unit 13 displays the generated third image data on a screen of a display device (not illustrated).

The display unit 13 may store the relationship information and the safety information in association with each other in a fifth database (not illustrated).

For example, the display unit 13 generates third image data including the relationship information and the safety information by combining first image data including the relationship information and second image data including the safety information. The display unit 13 displays the generated third image data on a display device (not illustrated).

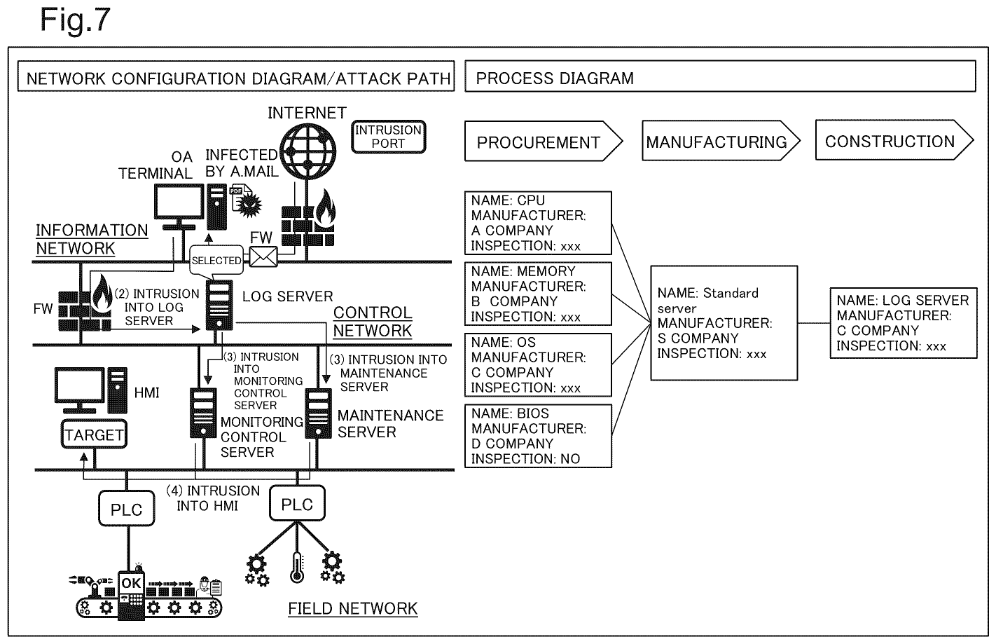

The display unit 13 may display the information indicating the attack path or the attack scenario set by the setting unit 34 together with or in association with the relationship information (FIGS. 7 to 9).

The display unit 13 may store the relationship information and the safety information in association with each other in a fifth database (not illustrated).

As described above, the operation of the data processing apparatus 30 according to the third example embodiment is ended.

Hereinafter, some specific examples of the relationship information and the safety information displayed by the display unit 13 according to the third example embodiment will be described with reference to FIGS. 7 to 9.

### (Example 1 of Relationship Information and Safety Information)

Here, an example in which the safety information is displayed together with the relationship information will be described. In the present example, the relationship information and the safety information are simultaneously displayed in the same image. Alternatively, the first image displaying the relationship information and the second image displaying the safety information may be switched and displayed.

A first example of the third image displayed by the display unit 13 of the data processing apparatus 30 will be described with reference to FIG. 7. The display unit 13 displays only relationship information and safety information related to the attack path among the relationship information received from the collecting unit 12 and the safety information received from the collecting unit 12. Here, in the third image, the first image and the second image are arranged in parallel on the left and right. The first image data includes the relationship information, and the second image data includes the safety information.

FIG. 7 is a diagram illustrating an example of the third image. As illustrated in FIG. 7, in an example, the third image includes, on a left side, a network configuration diagram corresponding to the first image, and includes, on a right side, a process diagram corresponding to the second image.

The network configuration diagram illustrates a network configuration of the communication system 1. An example of an attack path indicating a path from an intrusion port to a target by a cyberattack obtained through risk analysis for the communication system 1 is superimposed on the network configuration diagram illustrated in FIG. 7.

As described above, the setting unit 34 sets the attack path or the attack scenario of the cyberattack obtained through the risk analysis for the communication system 1. In FIG. 7, the attack path of the cyberattack obtained through the risk analysis for the communication system 1 set by the setting unit 34 is superimposed on the network configuration diagram.

The process diagram illustrates a supply chain from procurement of a constituent device of the communication system 1 to systemization (integration) of the communication system 1.

In the process diagram, “XXX” in “inspection: XXX” represents the content of software analysis performed for inspection. For example, the software analysis is source code analysis, binary code analysis, open source software (OSS) analysis, coding check, port scan, and software installation scan.

In FIG. 7, “log server” is selected on the network configuration diagram. Correspondingly, in the process diagram, only constituent devices of the communication system 1 related to the selected “log server” are displayed (second example embodiment). As illustrated in FIG. 7, in the process diagram, manufacturer names of these constituent devices and the presence or absence of inspection results of information security inspections for these constituent devices are illustrated as the safety information.

### (Example 2 of Relationship Information and Safety Information)

Here, an example in which the safety information is displayed in association with the relationship information will be described. In the present example, the relationship information and the safety information are simultaneously displayed in the same image. In the image, a position or a range in which the relationship information is displayed and a position or a range in which the safety information is displayed are related to each other.

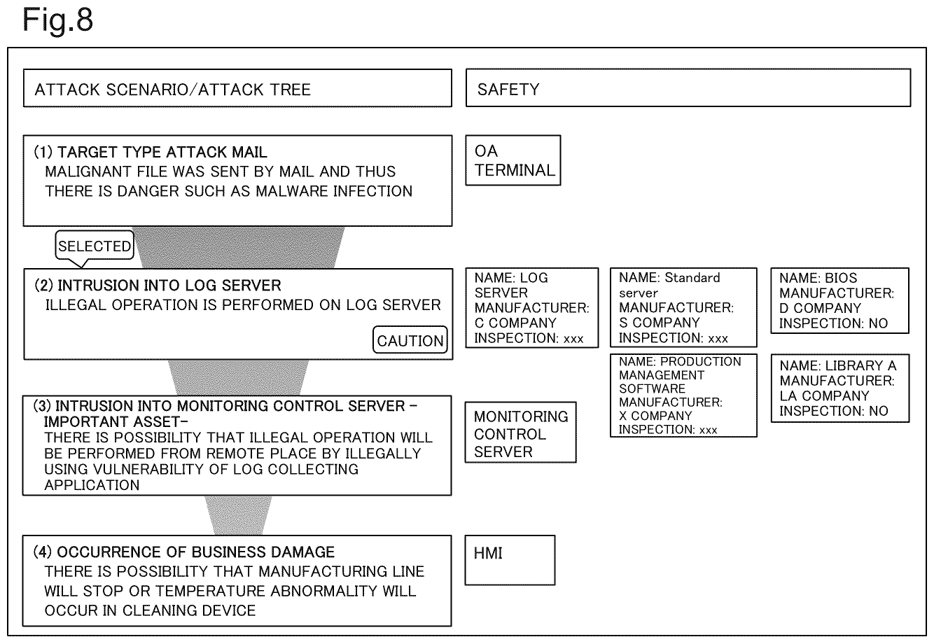

A second example of the third image displayed by the display unit 13 of the data processing apparatus 30 will be described with reference to FIG. 8. In the third image illustrated in FIG. 8, the first image and the second image are arranged in parallel on the left and right. The first image is a diagram illustrating an attack scenario that is an example of relationship information, and the second image is a diagram illustrating safety information.

The attack scenario represents a program of a cyberattack obtained through risk analysis for the communication system 1, the program being created based on settings of an attack object (intrusion port), an attack purpose (target), attack means, a resultant event (business damage), and the like.

In FIG. 8, the attack scenario is represented in the form of an attack tree indicating a series of procedures of the cyberattack. In each procedure, there are an attack object, an attack purpose, and attack means.

The safety information is information related to safety in terms of information security of a constituent device of the communication system 1. In FIG. 8, safety information is illustrated for a constituent device that is an attack object or an attack purpose.

In FIG. 8, “intrusion into log server” is selected on the attack tree. Correspondingly, in the process diagram, only constituent devices of the communication system 1 related to the attack procedure of the selected “intrusion into log server” are displayed. Specifically, in FIG. 8, “log server”, “Standard Server”, “production management software”, “BIOS”, and “library A” are illustrated as the constituent devices of the communication system 1 related to the attack procedure of “intrusion into log server”. As the safety information, manufacturer names regarding these constituent devices and the presence or absence of an inspection related to vulnerability of these constituent devices are illustrated.

### (Example 3 of Relationship Information and Safety Information)

Here, an example in which the safety information is displayed in association with the relationship information will be described. In the present example, the relationship information and the safety information are simultaneously displayed in the same image. In the image, a position or a range in which the relationship information is displayed and a position or a range in which the safety information is displayed are related to each other.

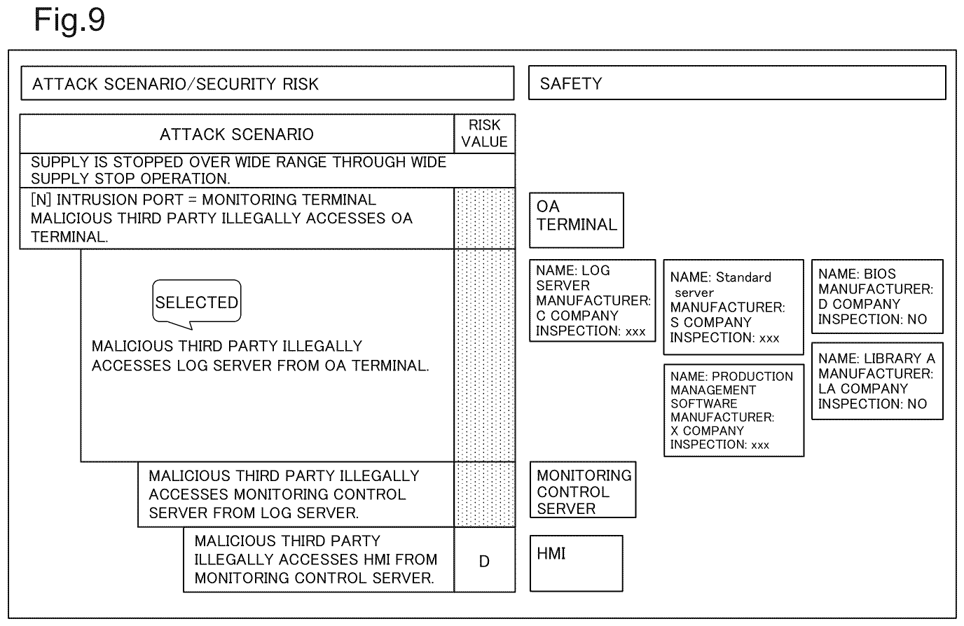

A third example of the third image displayed by the display unit 13 of the data processing apparatus 30 will be described with reference to FIG. 9. In the third image illustrated in FIG. 9, the first image and the second image are arranged in parallel on the left and right. The first image is a diagram illustrating an attack scenario that is an example of relationship information, and the second image is a diagram illustrating safety information.

In FIG. 9, a series of procedures (attack step) of the cyberattack is illustrated as the attack scenario. In each procedure, there are an attack object, an attack purpose, and attack means. In the diagram illustrating the attack scenario, a direction from left to right represents an advancing direction of time. The procedure illustrated on the left is performed earlier, and the procedure illustrated on the right is performed later.

The safety information is information related to safety in terms of information security of a constituent device of the communication system 1. In FIG. 9, safety information regarding a constituent device that is an attack object or an attack purpose is illustrated.

In the attack scenario illustrated in FIG. 9, the attack step of “A malicious third party illegally accesses the log server from the OA terminal.” in the second row from the top is selected. The display unit 13 acquires selection information of the attack step from an input device (not illustrated) or the like, and displays only constituent devices of the communication system 1 related to the selected attack step on the process diagram correspondingly.

Specifically, in FIG. 9, “log server”, “Standard Server”, “production management software”, “BIOS”, and “library A” are illustrated as the constituent devices of the communication system 1 related to the attack step of “A malicious third party illegally accesses the log server from the OA terminal.”. As the safety information, manufacturer names regarding these constituent devices and the presence or absence of an inspection related to vulnerability of these constituent devices are illustrated.

A “risk value” is illustrated on the right side of the attack scenario illustrated in FIG. 9. The risk value is an example of an index indicating the magnitude of a security risk. A “risk value” may be calculated by an evaluation unit (not illustrated) of the data processing apparatus 30.

In FIG. 9, the “risk value” is indicated as D. A method of calculating a risk value is not limited, but in one example, a method of evaluating a security risk based on an information-technology promotion agency (IPA) method is followed. According to the IPA method, the magnitude of a security risk depends on a threat level (likelihood of attack occurrence), a vulnerability level (likelihood of accepting a threat that has occurred), and the importance of an asset (for example, the economic value of the asset).

### Effects of Present Example Embodiment

According to the configuration of the present example embodiment, the acquisition unit 11 acquires identification information for identifying a specific constituent device of the communication system 1. The collecting unit 12 collects relationship information indicating a constituent component having a connection or a relationship with the specific constituent device and safety information related to safety in terms of information security of the specific constituent device and the constituent component by using the identification information. Relationship information indicating a connection or a relationship between the constituent devices of the communication system 1 is input. The display unit 13 displays the safety information together with or in association with the relationship information.

Since the relationship information and the safety information are displayed together instead of individually, there is comprehensiveness of information. With the comprehensiveness of information, not only the connection or the relationship between the constituent devices but also the safety of the constituent devices can be ascertained at a glance. Therefore, in the communication system 1, a factor (threat) that makes a security risk more evident can be accurately specified.

According to the configuration of the present example embodiment, the setting unit 34 sets the attack path or the attack scenario of the cyberattack obtained through the risk analysis for the communication system 1. The display unit 13 displays the relationship information and the safety information related to the attack path or the attack scenario. As a result, in a case where there is a cyberattack on the communication system 1, it is possible to predict a factor (threat) that makes a security risk of the communication system more evident.

### (Hardware Configuration)

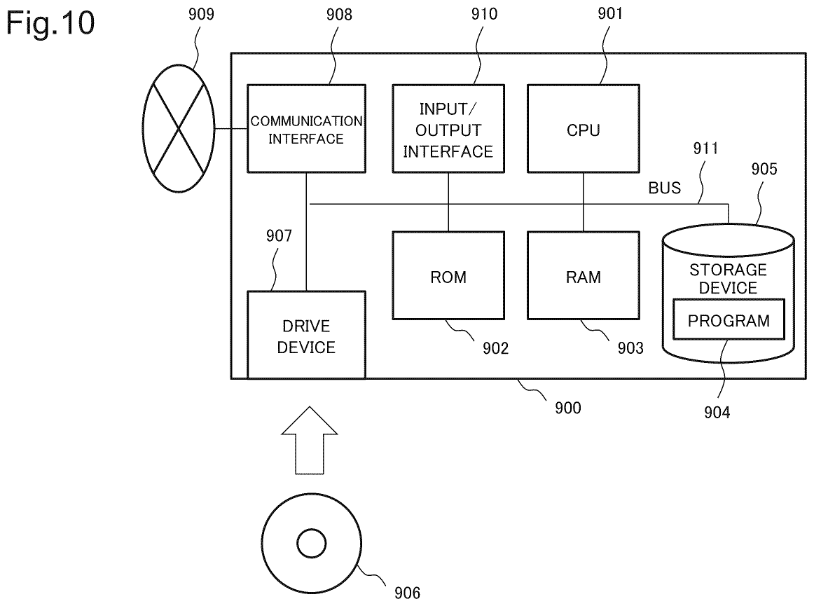

Each constituent element of the data processing apparatuses 10, 20, and 30 described in the first to third example embodiments indicates a block in the functional unit. Some or all of these constituent elements are implemented by an information processing device 900 as illustrated in FIG. 10, for example. FIG. 10 is a block diagram illustrating an example of a hardware configuration of the information processing device 900.

As illustrated in FIG. 10, the information processing device 900 includes the following configuration as an example.
Central processing unit (CPU) 901
Read only memory (ROM) 902
Random access memory (RAM) 903
Program 904 loaded into RAM 903
Storage device 905 storing program 904
Drive device 907 that performs reading and writing on recording medium 906
Communication interface 908 connected to communication network 909
Input/output interface 910 for inputting/outputting data
Bus 911 connecting respective constituent elements

The constituent elements of the data processing apparatuses 10, 20, and 30 described in the first to third example embodiments are implemented by the CPU 901 reading and executing the program 904 that achieves these functions. The program 904 for achieving the function of each constituent element is stored in the storage device 905 or the ROM 902 in advance, for example, and the CPU 901 loads the program into the RAM 903 and executes the program as necessary. Note that the program 904 may be supplied to the CPU 901 via the communication network 909, or may be stored in advance in the recording medium 906, and the drive device 907 may read the program and supply the program to the CPU 901.

According to the above configuration, the data processing apparatuses 10, 20, and 30 described in the first to third example embodiments are achieved as hardware. Therefore, an effect similar to the effect described in any one of the first to third example embodiments can be achieved.

### Supplementary Note

One aspect of the present invention can be described as, but not limited to, the following supplementary notes.

### Supplementary Note 1

An information providing device including:
acquisition means configured to acquire identification information for identifying a specific constituent device of a communication system;
collecting means configured to collect, by using the identification information, relationship information indicating a constituent component having a connection or a relationship with the specific constituent device and safety information related to safety in terms of information security of the specific constituent device and the constituent component; and
display means configured to display the safety information together with or in association with the relationship information.

### Supplementary Note 2

The information providing device according to Supplementary Note 1, in which
the display means displays the safety information in a manufacturing process diagram of the communication system.

### Supplementary Note 3

The information providing device according to Supplementary Note 2, in which
the display means displays the manufacturing process diagram in which the safety information is displayed together with a network configuration diagram of the communication system.

### Supplementary Note 4

The information providing device according to Supplementary Note 3, in which
the acquisition means acquires the identification information for identifying the specific constituent device selected from among constituent devices displayed on the network configuration diagram of the communication system.

### Supplementary Note 5

The information providing device according to any one of Supplementary Notes 1 to 4, further including:
setting means configured to set an attack path or an attack scenario of a cyberattack obtained through risk analysis for the communication system, in which
the acquisition means selects or designates the specific constituent device from among constituent devices related to the attack path or the attack scenario.

### Supplementary Note 6

The information providing device according to any one of Supplementary Notes 1 to 5, in which
the specific constituent device includes hardware and software, and parts and modules configuring the hardware and the software.

### Supplementary Note 7

The information providing device according to any one of Supplementary Notes 1 to 6, in which
the safety information includes an inspection result of an information security inspection for the specific constituent device.

### Supplementary Note 8

The information providing device according to any one of Supplementary Notes 1 to 6, in which
the safety information includes information specifying a product or a manufacturer of the specific constituent device.

### Supplementary Note 9

An information providing method including:
acquiring identification information for identifying a specific constituent device of a communication system;
collecting, by using the identification information, relationship information indicating a constituent component having a connection or a relationship with the specific constituent device and safety information related to safety in terms of information security of the specific constituent device and the constituent component; and
displaying the safety information together with or in association with the relationship information.

### Supplementary Note 10

The information providing method according to Supplementary Note 9, further including:
setting an attack path or an attack scenario assumed in a case where there is a cyberattack on the communication system; and
displaying the relationship information and the safety information related to the attack path or the attack scenario.

### Supplementary Note 11

A non-transitory recording medium storing a program for causing a computer to execute:
acquiring identification information for identifying a specific constituent device of a communication system;
collecting, by using the identification information, relationship information indicating a constituent component having a connection or a relationship with the specific constituent device and safety information related to safety in terms of information security of the specific constituent device and the constituent component; and
displaying the safety information together with or in association with the relationship information.

### Supplementary Note 12

The recording medium according to Supplementary Note 11, in which
the program causes the computer to further execute
setting an attack path or an attack scenario assumed in a case where there is a cyberattack on the communication system, and
displaying the relationship information and the safety information related to the attack path or the attack scenario.

Although the present invention has been described with reference to the example embodiments (and examples), the present invention is not limited to the above example embodiments (and examples). Various modifications that can be understood by those skilled in the art can be made to the configurations and details of the above example embodiments (and examples) within the scope of the present invention.

### INDUSTRIAL APPLICABILITY

The present invention can be used for a security inspection of a communication system, for example, for diagnosing vulnerability of information communication devices configuring the communication system and evaluating a security risk of the communication system.

### REFERENCE SIGNS LIST

1 communication system
10 data processing apparatus
11 acquisition unit
12 collecting unit
13 display unit
20 data processing apparatus
30 data processing apparatus
34 setting unit
100 node (control server)
200 node (client terminal)
300 switch
400 firewall

What is claimed is:

1. An information providing device comprising:
a memory configured to store instructions; and
at least one processor configured to run the instructions to perform:
acquiring identification information for identifying a specific constituent device of a communication system;
collecting, by using the identification information, relationship information indicating a constituent component having a connection or a relationship with the specific constituent device and safety information related to safety in terms of information security of the specific constituent device and the constituent component; and
displaying the safety information together with or in association with the relationship information.

2. The information providing device according to claim 1, wherein
the at least one processor is configured to run the instructions to perform:
displaying the safety information in a manufacturing process diagram of the communication system.

3. The information providing device according to claim 2, wherein
the at least one processor is configured to run the instructions to perform:
displaying the manufacturing process diagram in which the safety information is displayed together with a network configuration diagram of the communication system.

4. The information providing device according to claim 3, wherein
the at least one processor is configured to run the instructions to perform: acquiring the identification information for identifying the specific constituent device selected from among constituent devices displayed on the network configuration diagram of the communication system.

5. The information providing device according to claim 1, further comprising:
the at least one processor is configured to run the instructions to perform: setting an attack path or an attack scenario of a cyberattack obtained through risk analysis for the communication system, wherein
selecting or designating the specific constituent device from among constituent devices related to the attack path or the attack scenario.

6. The information providing device according to claim 1, wherein
the specific constituent device includes hardware and software, and parts and modules configuring the hardware and the software.

7. The information providing device according to claim 1, wherein
the safety information includes an inspection result of an information security inspection for the specific constituent device.

8. The information providing device according to claim 1, wherein
the safety information includes information specifying a product or a manufacturer of the specific constituent device.

9. An information providing method comprising:
acquiring identification information for identifying a specific constituent device of a communication system;
collecting, by using the identification information, relationship information indicating a constituent component having a connection or a relationship with the specific constituent device and safety information related to safety in terms of information security of the specific constituent device and the constituent component; and
displaying the safety information together with or in association with the relationship information.

10. The information providing method according to claim 9, further comprising:
setting an attack path or an attack scenario assumed in a case where there is a cyberattack on the communication system; and
displaying the relationship information and the safety information related to the attack path or the attack scenario.

11. A non-transitory recording medium storing a program for causing a computer to execute:
acquiring identification information for identifying a specific constituent device of a communication system;
collecting, by using the identification information, relationship information indicating a constituent component having a connection or a relationship with the specific constituent device and safety information related to safety in terms of information security of the specific constituent device and the constituent component; and
displaying the safety information together with or in association with the relationship information.

12. The recording medium according to claim 11, wherein
the program causes the computer to further execute
setting an attack path or an attack scenario assumed in a case where there is a cyberattack on the communication system, and
displaying the relationship information and the safety information related to the attack path or the attack scenario.
